(19) United States
(12) Patent Application Publication
(10) Pub. No.: US 2024/0190475 A1
(43) Pub. Date: Jun. 13, 2024

(54) TRAVEL AREA DETERMINATION DEVICE AND TRAVEL AREA DETERMINATION METHOD

(71) Applicant: Mitsubishi Electric Corporation, Tokyo (JP)

(72) Inventors: Yuji HAMADA, Tokyo (JP); Junichi OKADA, Tokyo (JP)

(73) Assignee: Mitsubishi Electric Corporation, Tokyo (JP)

(21) Appl. No.: 18/287,783

(22) PCT Filed: May 31, 2021
(86) PCT No.: PCT/JP2021/020716

§ 371 Date: Oct. 20, 2023

(51) Int. Cl. B60W 60/00

(52) U.S. Cl. CPC B60W 60/0027; B60W 2552/53; B60W 2556/40; B60W 2556/45

(57) ABSTRACT

An object of the present disclosure is to determine a travelable area with high accuracy even when other mobile objects exist in the vicinity. The travel area determination device includes an integration unit configured to integrate surrounding travel area information and travel area information, and an autonomous travel determination unit configured to determine an autonomous travelable area based on the integrated travel area information. A travel area creation unit is configured to determine a free space as a travelable area where a subject vehicle is travelable. The integration unit is configured to determine a travelable area where the surrounding mobile object is travelable as a surrounding travelable area where the subject vehicle is travelable, and integrate it and the travel area information. The autonomous travel determination unit is configured to determine the travelable area and the surrounding travelable area of the subject mobile object as the autonomous travelable areas.

### TECHNICAL FIELD

The present disclosure relates to travel area determination of a moving object.

### BACKGROUND ART

In recent years, autonomous self-driving systems utilizing surrounding monitoring sensors such as cameras or millimeter-wave sensors installed on mobile objects such as vehicles have begun to proliferate. Examples include a lane keep assist system which controls the vehicle to maintain the lane during travel, or a lane change system which controls the vehicle to perform lane changes under certain conditions. Self-driving systems determine an area in which the vehicle is traveling and create a traveling route using information, such as of lane markings or of obstacles detected by the sensors, and high-definition map information.

Patent Document 1 discloses a technique for creating a route for traveling on a shoulder or the like, or a route for traveling a preceding vehicle in situations where an obstacle exists ahead of the vehicle and lane changes are impossible.

Patent Document 2 discloses a technique for creating a travelable area of a vehicle based on lane marker information on a travel path and information on objects around the vehicle, and creating a target route within the travelable area.

### PRIOR ART DOCUMENTS

### Patent Document(s)

[Patent Document 1] Japanese Patent Application Laid-Open No. 2019-197399
[Patent Document 2] International Publication No. 2020/157532

### SUMMARY

### Problem to be Solved by the Invention

In self-driving systems using surrounding monitoring sensors, there has been a problem that, occlusion occurs by other mobile objects in the surroundings, which causes existence of areas where sensing cannot be performed, resulting in errors in determining the travelable area.

The present disclosure has been made to solve the above-mentioned problem, and an object thereof is to determine an area in which a subject mobile object can perform autonomous traveling even when other mobile objects exist around the subject mobile object with high accuracy.

### Means to Solve the Problem

A travel area determination device of the present disclosure includes a travel area creation unit configured to determine an area type of a surrounding area of a subject mobile object based on measurement information from a surrounding monitoring sensor installed in the subject mobile object and create travel area information including information about the area type, an integration unit configured to integrate surrounding travel area information including the information about the area type of a surrounding area of a surrounding mobile object, which is determined based on a measurement result of the surrounding monitoring sensor installed in the surrounding mobile object which is a mobile object present around the subject mobile object and the travel area information, and an autonomous travel determination unit configured to determine an autonomous travelable area, where the subject mobile object is autonomously travelable, based on the integrated travel area information, the travel area creation unit is configured to determine a free space being an area between the subject mobile object and an obstacle as a travelable area where the subject mobile object is travelable based on a position of the obstacle existing around the subject mobile object measured by the surrounding monitoring sensor installed in the subject mobile object, the integration unit is configured to determine a travelable area where the surrounding mobile object is travelable, which is determined based on the measurement result of the surrounding monitoring sensor installed in the surrounding mobile object, as a surrounding travelable area where the subject mobile object is travelable, and integrate the travelable area and the travel area information, the autonomous travel determination unit is configured to determine the travelable area and the surrounding travelable area of the subject mobile object as the autonomous travelable areas, and a travel route the subject mobile object autonomously travels is created in the autonomous travelable area.

### Effects of the Invention

According to the technology of the present disclosure, the automatic travelable area is determined with high accuracy even when other mobile objects exist in the surroundings of the subject mobile object. The objects, features, aspects, and advantages of the present disclosure will become more apparent from the following detailed description and the accompanying drawings.

### BRIEF DESCRIPTION OF DRAWINGS

FIG. 1 A block diagram of a travel area determination device of Embodiment 1.

FIG. 2 A diagram illustrating an example of travel area determination of Embodiment 1.

FIG. 3 A diagram illustrating an example of the travel area determination of Embodiment 1.

FIG. 4 A diagram illustrating an example of travel area determination of Embodiment 1 when surrounding vehicles exist.

FIG. 5 A diagram illustrating an example of travel area determination of Embodiment 1 when surrounding vehicles exist.

FIG. 6 A table illustrating an example of a travel area determination table of Embodiment 1.

FIG. 7 A diagram illustrating an example of integrating travel areas of the surrounding vehicles of Embodiment 1.

FIG. 8 A diagram illustrating an example of integrating travel areas of the surrounding vehicles of Embodiment 1.

FIG. 9 A diagram illustrating an example of the travel area using predicted trajectories of the surrounding vehicles of Embodiment 1.

FIG. 10 A diagram illustrating an example of the travel area using predicted trajectories of the surrounding vehicles of Embodiment 1.

FIG. 11 A diagram illustrating an example of determination of a travel area at an intersection.

FIG. 12 A diagram illustrating an example of determination of a no-stop area at the intersection.

FIG. 13 A diagram illustrating an example of determination of a no-stop area at the intersection.

FIG. 14 A diagram illustrating an example of determination of entry prohibition at an intersection.

FIG. 15 A diagram illustrating an example of determination of entry prohibition at an intersection.

FIG. 16 A diagram illustrating an example of determination of a traveling lane.

FIG. 17 A table illustrating an example of determination of traveling lanes.

FIG. 18 A flow chart illustrating overall processing of a travelable determination device of Embodiment 1.

FIG. 19 A flow chart illustrating processing of a traveling lane estimation unit of Embodiment 1.

FIG. 20 A flow chart illustrating processing of a subject vehicle travel area determination unit of Embodiment 1.

FIG. 21 A flow chart illustrating processing of a travel area integration unit of Embodiment 1.

FIG. 22 A flowchart illustrating processing an attribute identification unit of Embodiment 1.

### DESCRIPTION OF EMBODIMENT(S)

### A. Embodiment 1

### <A-1. Configuration>

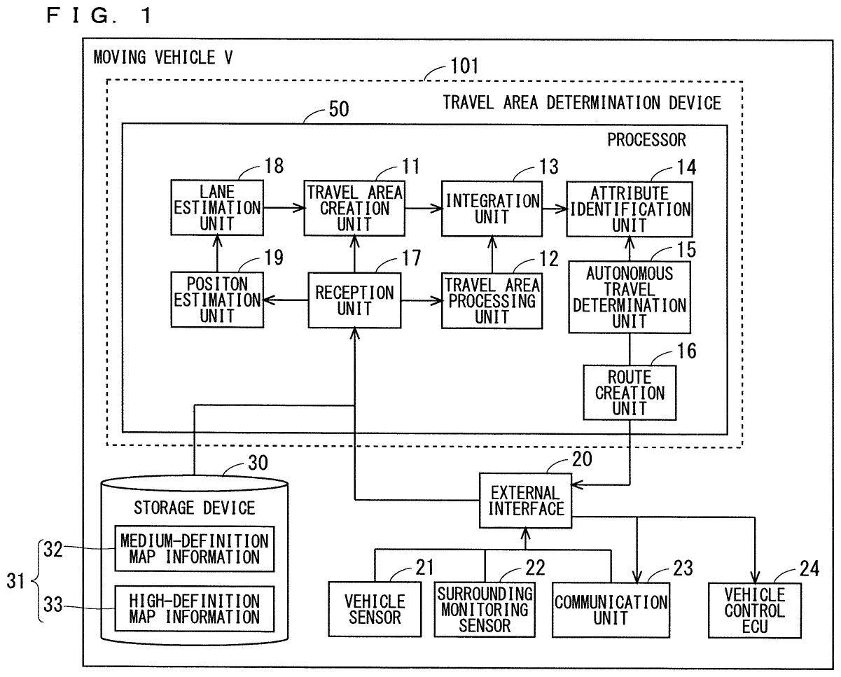

FIG. 1 is a block diagram of a travel area determination device 101 of Embodiment 1. The travel area determination device 101 determines an area in which a vehicle is travelable (hereinafter referred to as “travelable area”) from the surrounding area of the vehicle, and creates a route for traveling in the travelable area. Hereinafter, a vehicle subjected to determination of a travelable area by the travel area determination device 101 is referred to as a subject vehicle, and an other vehicle traveling around the subject vehicle is referred to as a surrounding vehicle. A vehicle is an example of a mobile object. The subject vehicle may also be referred to as a subject mobile object, and the surrounding vehicle may also be referred to as a surrounding mobile object.

In FIG. 1, the travel area determination device 101 is mounted on a subject vehicle V. However, the travel area determination device 101 may be distributed to the subject vehicle V, a cloud server or an edge server provided outside the subject vehicle V, or a roadside device, or may also be arranged collectively in one of them.

The travel area determination device 101 is configured by a processor 50. The travel area determination device 101 is connected to a vehicle sensor 21, a surrounding monitoring sensor 22, a communication unit 23, and a vehicle control ECU 24 via an external interface 20, and is also connected to a storage device 30, and is configured to be able to use them.

The processor 50 is connected to other hardware including the storage device 30 and the external interface via signal lines, and controls these other hardware. The processor 50 is an Integrated Circuit (IC) for executing instructions written in a program and executing processes such as data transfer, calculation, processing, control, and management. The processor 50 includes an arithmetic circuit and a register and a cache memory in which instructions and information are stored. The processor 50 is specifically a Central Processing Unit (CPU), a Digital Signal Processor (DSP), or a Graphics Processing Unit (GPU). In the processor 50, the arithmetic circuit executes the program to implement a travel area creation unit 11, a travel area processing unit 12, an integration unit 13, an attribute identification unit 14, an autonomous travel determination unit 15, a route creation unit 16, a reception unit 17, a lane estimation unit 18, and a position estimation unit 19. Although one processor 50 is illustrated in FIG. 1, the travel area determination device 101 may include a plurality of processors 50. In this case, the plurality of processors 50 cooperatively execute a program that implements the functions of the travel area creation unit 11 and the like.

The external interface 20 includes a receiver that receives data from a surrounding vehicle and a transmitter that transmits data to the surrounding vehicle. The external interface 20 is specifically a port for an LSI (Large Scale Integration) for sensor data acquisition, a Universal Serial Bus (USB), or a Controller Area Network (CAN).

The vehicle sensor 21 detects vehicle information including the latitude, longitude, altitude, speed, azimuth, acceleration, or yaw rate of the subject vehicle V in a periodic manner, and notifies the external interface 20 of the detected vehicle information. The vehicle sensor 21 includes a Global Positioning System (GPS), a speed sensor, an acceleration sensor, or an azimuth sensor connected to an in-vehicle Electronic Control Unit (ECU), an Electric Power Steering (EPS), an automotive navigation system, or a cockpit.

The surrounding monitoring sensor 22 includes a positioning sensor. The positioning sensor includes a millimeter wave radar, a monocular camera, a stereo camera, a Light Detection and Ranging, Laser Imaging Detection and Ranging (LiDAR), a sonar, a Global Positioning System (GPS), and the like. Also, the surrounding monitoring sensor 22 includes a Driver Monitoring System (DMS) that monitors a driver on board the subject vehicle V, or a drive recorder. The surrounding monitoring sensor 22 measures obstacles, lane markings, and free space around the subject vehicle V in a periodic manner. The free space refers to an area where no obstacles exist. Measurement information of the surrounding monitoring sensor 22 is referred to as surrounding monitoring sensor information. Specifically, the surrounding monitoring sensor information includes obstacle information, lane marking information, and free space information. The obstacle information includes information on the position, speed, angle and type of a surrounding vehicle. The lane marking information includes information on the position, shape and line type of lane markings. The free space information includes information on coordinates, angle and type of the free space.

The communication unit 23 adopts communication protocols such as Dedicated Short Range Communication (DSRC) dedicated to vehicle communication and IEEE802.11p. Also, the communication unit 23 may adopt a cellular network such as Long Term Evolution (LTE, registered trademark) or a fifth generation mobile communication system (5G). Also, the communication unit 23 may adopt a wireless LAN such as Bluetooth (registered trademark) or IEEE802.11a/b/g/n/ac. The communication unit 23 receives surrounding vehicle information from a surrounding vehicle and notifies the external interface 20 of the received surrounding vehicle information. The surrounding vehicle information includes vehicle information of the surrounding vehicle, surrounding monitoring sensor information measured by the surrounding monitoring sensor 22 mounted on the surrounding vehicle, and travel area information of the surrounding vehicle.

The vehicle control ECU 24 controls the accelerator, brake, and steering of the subject vehicle V. The vehicle control ECU 24 is notified of vehicle control information including a travel route and a target speed of the subject vehicle V from the external interface 20, and controls the subject vehicle V according to the notified vehicle control information.

The storage device 30 stores map information 31. The storage device 30 includes, for example, a Random Access Memory (RAM), a Hard Disk Drive (HDD), or a Solid State Drive (SSD). The storage device 30 may also include a portable storage media such as a Secure Digital (SD, registered trademark) memory card, a Compact Flash (CF, registered trademark), a NAND flash, a flexible disk, an optical disk, a compact disk, a Blu-ray (registered trademark) disk, a DVD.

The map information 31 includes medium-definition map information 32 and high-definition map information 33. The high-definition map information 33 is composed of a plurality of map information layers that are hierarchically structured to correspond to predefined scales. The high-definition map information 33 includes road information, lane information, and configuration line information. The road information refers to information related to roads, including road shapes, latitude, longitude, curvature, gradient, identifiers, lane count, road type, and attributes thereof. The information regarding road attributes refers to, information indicating whether a road is classified as a regular road, a highway, or a priority road, for example. The lane information refers to information regarding the lanes that comprises a road, including lane identifiers, latitude, longitude, and information about the centerline of the road. The configuration line information refers to information regarding the lines (referred to as “configuration lines”) that form the lanes, and includes information such as configuration line identifiers, latitude, longitude, line type, curvature. The road information is managed for each road, and lane information and configuration line information are managed for each lane.

The high-definition map information 33 is used for navigation, driving assistance, autonomous driving, and the like. The high-definition map information 33 may be a dynamic map containing dynamic information that changes with time. The dynamic information included in the high-definition map information 33 includes traffic regulation information, toll booth regulation information, traffic congestion information, traffic accident information, obstacle information, road anomaly information, and surrounding vehicle information. The traffic regulation information includes information regarding lane restrictions, speed limits, road closures, or chain requirements, among others. The traffic accident information includes information of stopped vehicles or slow-moving vehicles. The obstacle information includes information about fallen objects or animals on the road. The road anomaly information includes information about areas where the road is damaged or where abnormalities have occurred on the road surface.

The medium-definition map information 32 includes road information. The medium-definition map information 32, unlike high-definition map information 33, does not include the lane information or the configuration line information, and the road information included thereof contains errors in road information such as latitude and longitude of roads.

The travel area creation unit 11 retrieves vehicle information of the subject vehicle V, surrounding monitoring sensor information of the subject vehicle V, surrounding vehicle information, high-definition map information 33, and medium-definition map information 32 from the reception unit 17. Also, the travel area creation unit 11 retrieves information on the travel lane of the subject vehicle V (hereinafter referred to as travel lane information) from the lane estimation unit 18. The travel area creation unit 11 uses the information to determine the area type of the surrounding area of the subject vehicle V and creates travel area information that includes information about the area type.

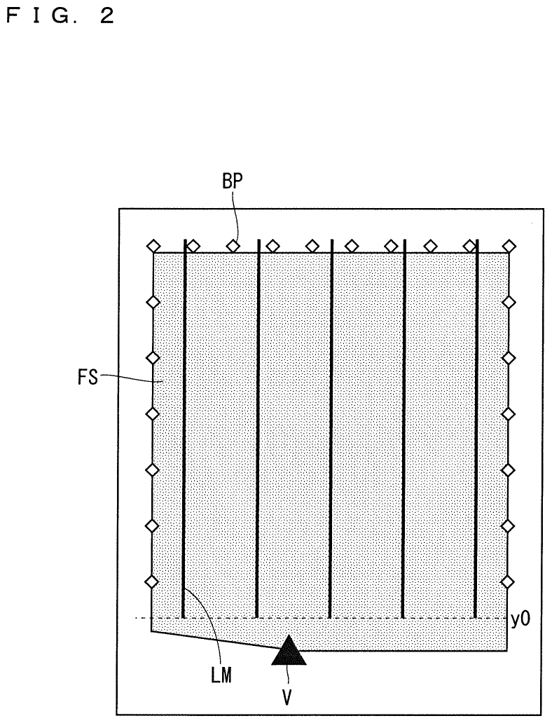

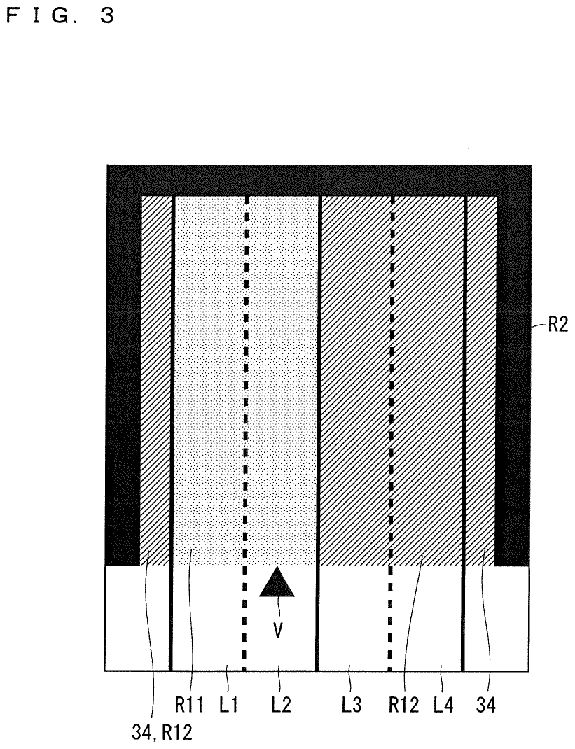

FIGS. 2 and 3 illustrate the travel area information created by the travel area creation unit 11, represented on a map. The representation of travel area information on a map is also referred to as a travel area map. The travel area creation unit 11 creates the travel area map, as illustrated in FIG. 2, using the position information of the subject vehicle V, free space information, and lane marking information. In the surrounding area of the subject vehicle V, obstacles such as curbs or guardrails are detected as boundary points BP, and the area between the boundary points BP and the subject vehicle V becomes the free space FS. The lane marking information includes information about lane markings LM detected by the surrounding monitoring sensor 22. Here, the travel area creation unit 11 may use the medium-definition map information 32 to correct the information of the lane markings LM detected by the surrounding monitoring sensor 22. Specifically, the travel area creation unit 11 combines the y-intercept position y0 of the lane marking LM detected by the surrounding monitoring sensor 22 (see FIG. 2) with the curvature information of the road included in the medium-definition map information 32 to set the shape of the lane marking LM in the travel area map. In the case of a straight road, all lane markings LM may be set to the same curvature. In the case of curved roads, different curvatures are set for each lane marking LM and offsets are given accordingly. In this manner, the travel area creation unit 11 corrects the shape of the lane marking detected by the surrounding monitoring sensor 22 using the curvature information included in the medium-definition map information 32, and then, based on the corrected shape of the lane marking, estimates the travel lane of the subject vehicle V. Further, the travel area creation unit 11 sets the number of lane markings LM in the travel area map based on the lane count retrieved from the medium-definition map information 32.

The travel area creation unit 11 uses the travel area map illustrated in FIG. 2, along with information about travel lanes, the lane count, and lane markings, to determine the area type of the surrounding area of the subject vehicle V to create the travel area information.

In the example illustrated in FIG. 3, within the free space FS, the travel lane L2 for the subject vehicle V and the lane L1 directing in the same direction as the travel lane L2 (referred to as a same-direction lane) are determined as a regular travelable area R11. Also, within the free space FS, the oncoming lanes L3, L4, and shoulders 34 are determined as an emergency travelable area R12. In addition, the surrounding area other than the free space FS is determined as a non-travel area R2. Both the regular travelable area R11 and the emergency travelable area R12 are area where the subject vehicle V is travelable. However, the emergency travelable area R12 has a lower priority for the traveling of the subject vehicle V compared to the regular travelable area R11. The route creation unit 16 creates a travel route for the subject vehicle V within the emergency travelable area R12 only during emergency situations, such as when no regular travelable area is available. The combination of the regular travelable area and the emergency travelable area is simply referred to as a travelable area. The non-travel area R2 is an area where the subject vehicle V does not travel.

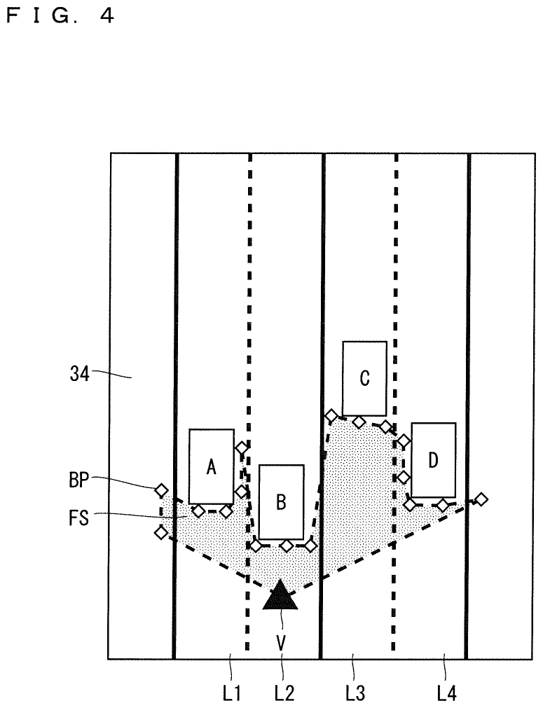

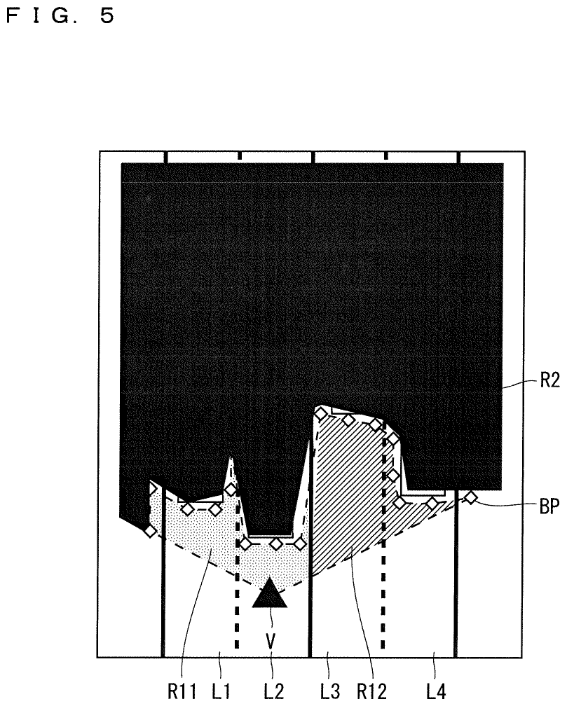

FIGS. 2 and 3 illustrate the example where no surrounding vehicles are present. Whereas, FIGS. 4 and 5 illustrate the travel area information when surrounding vehicles A, B, C, and D are present ahead of the subject vehicle V.

As illustrated in FIG. 4, the boundary points BP are provided along the surrounding vehicles A, B, C, and D, and the area among the boundary points BP and the subject vehicle V becomes the free space FS.

As illustrated in FIG. 5, within the free space FS, the travel lane L2 of the subject vehicle V and the same-direction lane L1 are determined as the regular travelable area R11. Also, within the free space FS, the oncoming lanes L3, L4, and shoulders 34 are determined as the emergency travelable area R12. In addition, the surrounding area other than the free space FS is determined as the non-travel area R2.

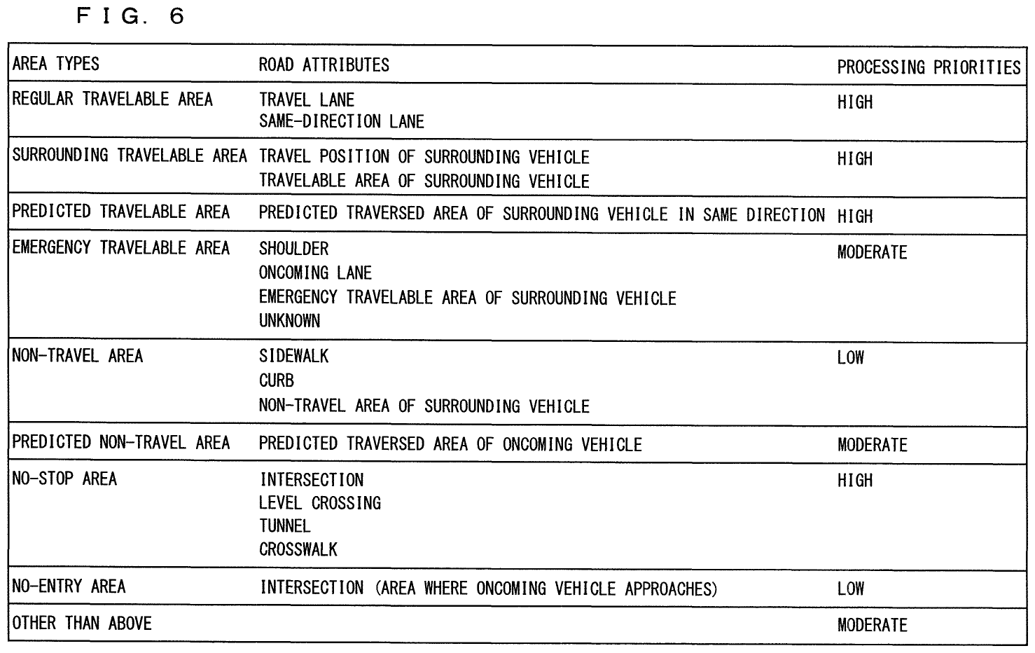

FIG. 6 illustrates the relationship between area types, road attributes, and processing priorities. As illustrated in FIG. 6, the travel lanes and the same-direction lanes are categorized in the regular travelable area, and the shoulders, the oncoming lanes, and the emergency travelable areas of surrounding vehicles in the same direction are categorized in the emergency travelable area. The sidewalks, curbs, and the non-travel areas of surrounding vehicles are categorized in the non-travel area. The positions of surrounding vehicles and the travelable areas are categorized in the surrounding travelable area. The area predicted to be traversed by the subject vehicle before coming to a stop when surrounding vehicles traveling in the same direction abruptly halt is determined as a predicted travelable area. Intersections, level crossings, tunnels, or crosswalks are determined as a no-stop area. The area within an intersection where an oncoming vehicle is approaching is determined as a no-entry area. The travel area information includes information about these area types in relation to the surrounding area.

Further, as illustrated in FIG. 6, processing priorities are assigned based on the area type or road attributes. The processing priorities for the regular travelable area, the surrounding travelable area, the predicted travelable area, and the no-stop area are high. The processing priorities for the emergency travelable area and the predicted non-travel area are moderate. The processing priorities for the non-travel area and the no-entry area are low. The higher the processing priority, the higher the processing frequency and the shorter the processing cycle. The travel area creation unit 11 uses the area type determined in the previous process, for example, to prioritize a process or skip a process in the next determination process. The travel area creation unit 11 may determine the area type or the road attributes by synthesizing the types or the road attributes determined in previous iterations with the types or road attributes determined in the current iteration, taking into account the number of determinations made within a certain period of time.

The travel area processing unit 12 receives the position of surrounding vehicles and surrounding travel area information, which is the travel area information of the surrounding vehicles, from the reception unit 17, and outputs them to the integration unit 13. The surrounding travel area information includes information about the area type of the surrounding area of the surrounding vehicles, which is determined based on the surrounding monitoring sensor information by the surrounding monitoring sensor 22 installed in the surrounding vehicles. The travel area processing unit 12 receives the surrounding monitoring sensor information by the surrounding monitoring sensor 22 installed on the surrounding vehicles. However, if the travel area processing unit 12 does not receive the travel area information from the surrounding vehicles, it creates the travel area information for the surrounding vehicles based on their positions and the free space information using the same method as the travel area creation unit 11 creates the travel area information for the subject vehicle.

The integration unit 13 retrieves the travel area information for the subject vehicle V from the travel area creation unit 11 and retrieves the surrounding travel area information from the travel area processing unit 12. The integration unit 13 integrates the surrounding travel area information into the travel area information for the subject vehicle V based on the positional relationship between the subject vehicle V and the surrounding vehicles.

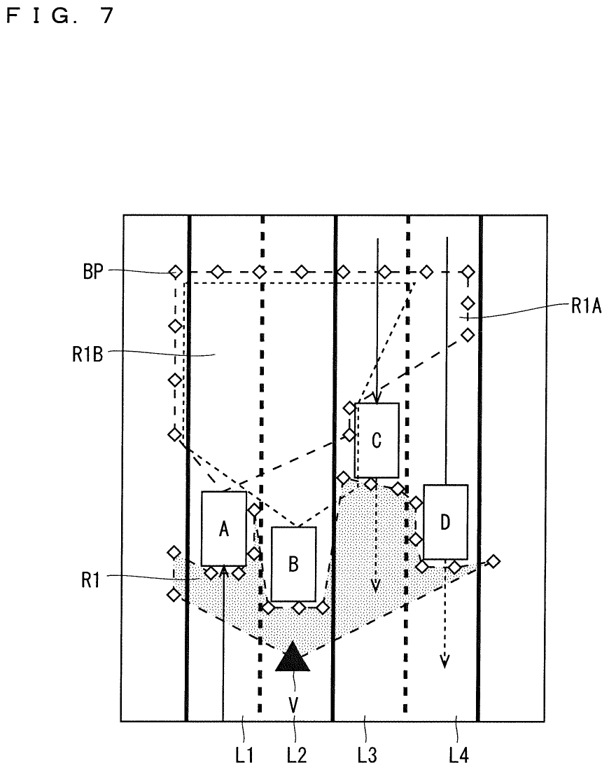

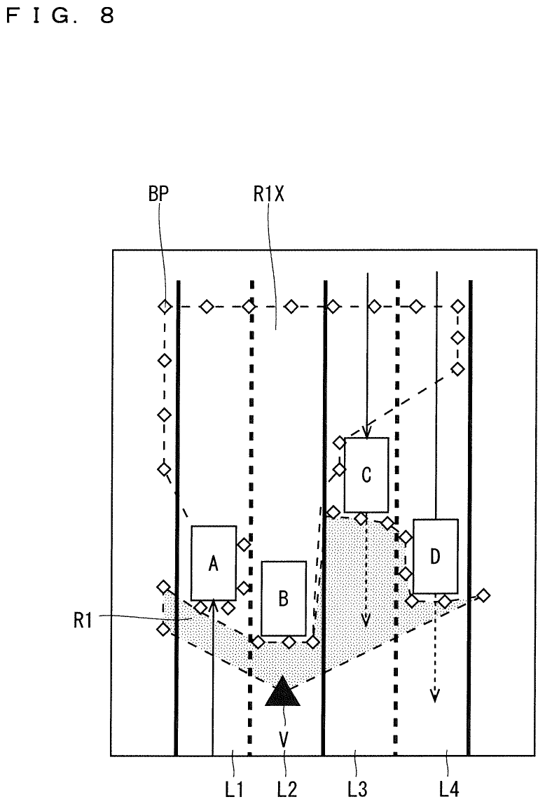

FIGS. 7 and 8 illustrate an example of the integration of the travel area information of the subject vehicle V and the travel area information of the surrounding vehicles A and B. The surrounding vehicles A and B are traveling, ahead of the subject vehicle V, in the same direction as the subject vehicle V is. As illustrated in FIG. 7, there is a travelable area RIA of the surrounding vehicle A ahead thereof, and similarly, there is a travelable area RIB of the surrounding vehicle B ahead thereof. The travelable area R1A and the travelable area R1B partially overlap with each other. Also, there is a travelable area R1 for the subject vehicle V between the subject vehicle V and the surrounding vehicles A, B, C, and D.

As illustrated in FIG. 8, the travelable area RIA of the surrounding vehicle A and the travelable area RIB of the surrounding vehicle B are integrated as a surrounding travelable area RIX, which is defined separately from the travelable area R1 of the subject vehicle V.

When integrating the travel area information of the subject vehicle V with the travel area information of the surrounding vehicles, the integration unit 13 may change the processing priority based on the area types illustrated in FIG. 6 and integrate them in order of higher priority. Also, the integration unit 13 may process the travelable areas of the surrounding vehicles in order of proximity to the subject vehicle V or process the travelable areas of the surrounding vehicles in order of higher collision risk with the subject vehicle V. Further, the integration unit 13 may change certain travelable areas, such as areas narrower than the width of the subject vehicle V, which are physically impossible to travel through, to the non-travel areas.

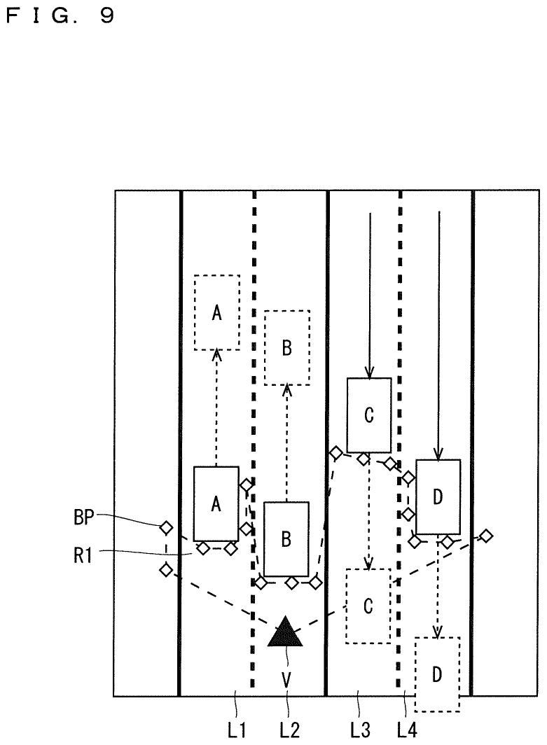

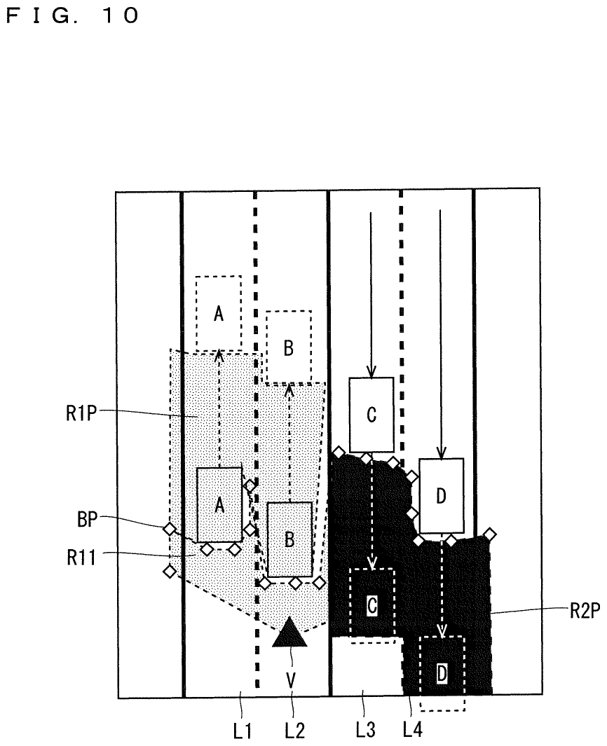

FIGS. 9 and 10 illustrate an example of the integration of the travel area information of the subject vehicle V and the travel area information of the surrounding vehicles A, B, C, and D. The surrounding vehicles A and B are vehicles traveling, ahead of the subject vehicle V, in the same direction as the subject vehicle V is, while the surrounding vehicles C and D are oncoming vehicles. In FIG. 9, positions, at which the surrounding vehicles A, B, C, and D are predicted to stop after the surrounding vehicles A, B, C, and D initiate emergency braking from the current moment, (referred to as a predicted stopping positions) are indicated by dotted lines. The predicted stopping positions are predicted using the positions, azimuth, or yaw rates of the surrounding vehicles A, B, C, and D. The integration unit 13 determines an area from the current positions of the surrounding vehicles A and B, which are traveling in the same direction as the subject vehicle V to their predicted stopping positions as a predicted travelable area RIP. Also, the integration unit 13 determines an area from the current positions of the surrounding vehicles being the oncoming vehicles C and D to their predicted stopping positions as a predicted non-travel area R2P.

The integration unit 13 may compare the travel area information of the subject vehicle V with the travel area information of the surrounding vehicles, and when there is a difference in the area type or the road attributes for the same location between them, the integration unit 13 may adopt the travel area information of the nearest vehicle from this point. Further, in a case where there are differences in the area types or the road attributes for the same location among the travel area information of a plurality of surrounding vehicles, the result that appears most frequently may be adopted. Due to the presence of errors in the position information and the travel area information of the subject vehicle V and the surrounding vehicles, the integration unit 13 compensates for these errors by aligning the feature points in the travel area information of the subject vehicle V and the surrounding vehicles, thereby integrating the travel area information. In addition, when using the travel area information of the plurality of surrounding vehicles, the integration unit 13 may increase the frequency of determining the points where there are differences between the area types or the road attributes among the travel area information of each surrounding vehicle, while reducing the frequency of determining the points where the area types or the road attributes are the same among the travel area information of each surrounding vehicle.

In this manner, the travel area information of the subject vehicle V and the travel area information of the surrounding vehicles are integrated. The integration unit 13 outputs the information of the integrated travel area to the attribute identification unit 14.

The attribute identification unit 14 retrieves the travel area information from the integration unit 13. The attribute identification unit 14 detects areas of specific road attribute that include at least one of intersections, level crossings, tunnels, and crosswalks based on map information and the shape of surrounding areas and identifies these areas as no-stop areas where the subject vehicle is prohibited from stopping.

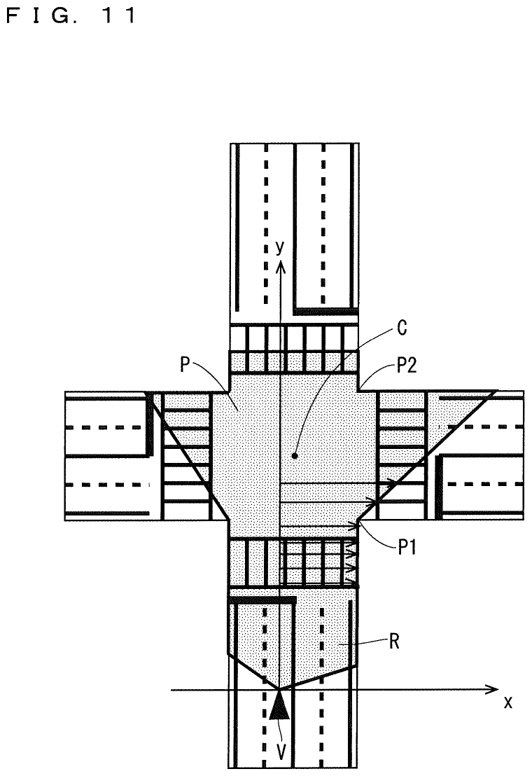

FIG. 11 illustrates a method of detecting a position of an intersection P based on the shape of a surrounding area R. The surrounding area R is an area detected by the surrounding monitoring sensor 22. The corners of intersection P become blind spots for the surrounding monitoring sensor 22 installed on the subject vehicle V, so the outer shape of the surrounding area R at the intersection P becomes diagonal.

The attribute identification unit 14 sets a starting point P1 and an ending point P2 of the intersection P using the medium-definition map information 32. Specifically, the attribute identification unit 14 sets the x-axis in the direction of lane width and the y-axis in the direction of travel, taking the current position of the subject vehicle V as the starting point. Further, the attribute identification unit 14 retrieves a distance D from the subject vehicle V to a center point C of intersection P and the lane count N intersecting at the intersection P from the medium-definition map information 32. Then, the attribute identification unit 14 sets the y-axis direction area as the position of the intersection P by taking the center point C as the center by lane count N×width W. In other words, the starting point P1 of the intersection P is set as (C−N/2×W), and the ending point P2 of the intersection P is set as (C+N/2×W).

Further, the attribute identification unit 14 determines the starting point P1 and the ending point P2 of the intersection P based on the coordinates of the boundaries of the surrounding area R. Specifically, when the value along the y-axis increases along the boundaries of the surrounding area R, and after reaching a certain constant value along the x-axis, it sharply increases, the attribute identification unit 14 determines that the point where the x-axis value sharply increases is the starting point P1 of the intersection P. Further, when the value along the x-axis increases along the boundaries of the surrounding area R while the value along the y-axis remains within a certain range, the attribute identification unit 14 determines that point as the ending point P2 of the intersection P. Accordingly, the attribute identification unit 14 corrects the positions of the starting point P1 and the ending point P2 of the intersection P, which are set using the medium-definition map information 32.

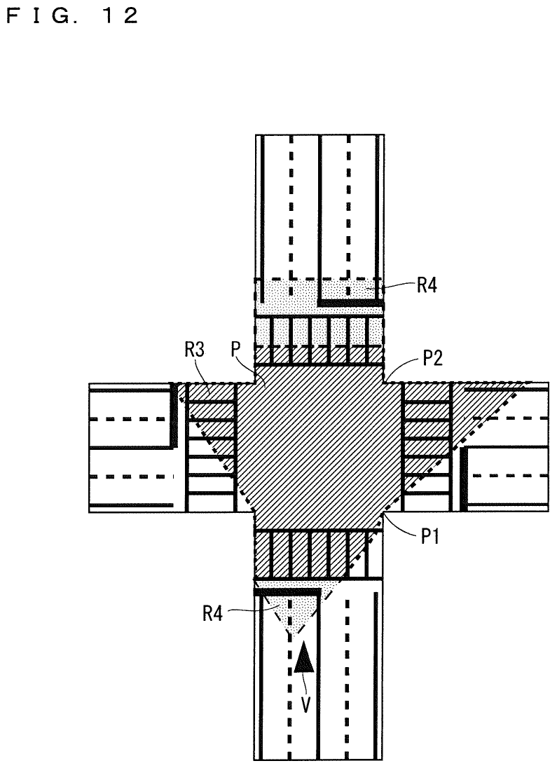

FIG. 12 illustrates a state where a no-stop area R3 is set in the intersection P. In an example illustrated in FIG. 12, the no-stop area R3 is set to include a certain range before the starting point P1 and a certain range after the ending point P2 of the intersection P. Also, a stop-allowed area R4 is set to include a certain range before the no-stop area R3 and a certain range after the no-stop area R3. The attribute identification unit 14 may adjust the ending point of the stop-allowed area R4 before the intersection P and the starting point of the stop-allowed area R4 after the intersection P to align with the position of the stop line detected by the surrounding monitoring sensor 22.

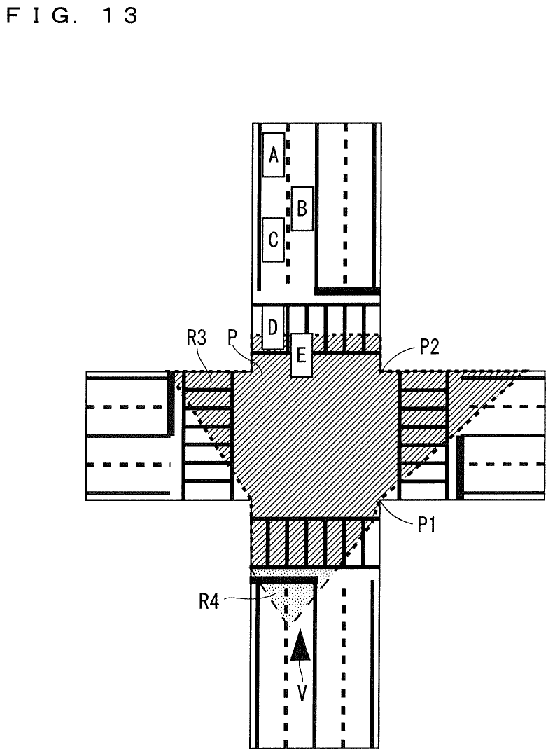

Setting up the no-stop area R3 and the stop-allowed area R4 in the travel area information in this manner ensures determining whether the subject vehicle V should enter the intersection P based on the traffic conditions at the intersection P or beyond. FIG. 13 illustrates a situation where surrounding vehicles A, B, C, D, and E are stopped at or before the intersection P in front of the subject vehicle V, and the surrounding vehicles D and E are within the no-stop area R3. In this state, the subject vehicle V would inevitably have to come to a stop within the no-stop area R3 if it were to enter the intersection P. Therefore, the subject vehicle V stops at the stop-allowed area R4 right before the intersection P.

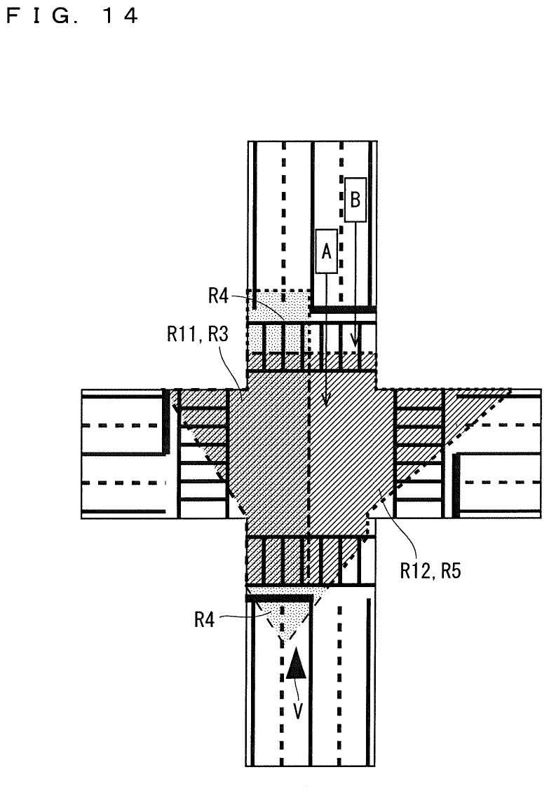

The attribute identification unit 14 may dynamically modify the travel area information based on the position of surrounding vehicles or the signal light color. FIG. 14 illustrates a state where the surrounding vehicles A and B, which are oncoming vehicles, are approaching the intersection P while the subject vehicle V is making a right turn. It is assumed that the travel area creation unit 11 sets an area that is not within the travel lane of the subject vehicle V or on the extension line of the same lane at the intersection P as the emergency travelable area R12. However, considering that the surrounding vehicles A and B are approaching the intersection P, the attribute identification unit 14 changes the emergency travelable area R12 within the intersection P to the no-entry area R5. Afterward, when the surrounding vehicles A and B pass through the intersection P, the attribute identification unit 14 restores the no-entry area R5 within the intersection P back to the emergency travelable area R12.

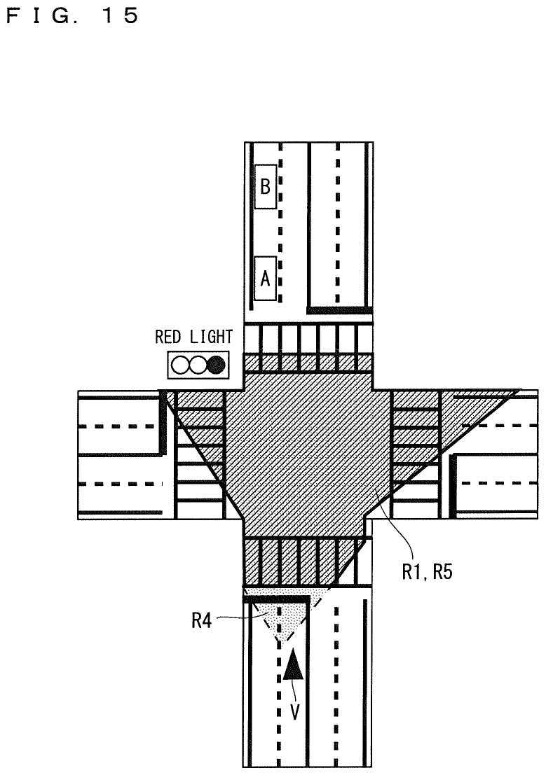

FIG. 15 illustrates a case where the signal at the intersection P ahead of the subject vehicle V is red. It is assumed that the travel area creation unit 11 sets the intersection P as the regular travelable area R11. However, considering that the signal at the intersection P is red, the attribute identification unit 14 changes the regular travelable area R11 within the intersection P to the no-entry area R5. Afterward, when the signal at the intersection P turns blue, the attribute identification unit 14 restores the no-entry area R5 within the intersection P back to the regular travelable area R11.

While FIG. 15 illustrates an example of the signal at the intersection P being red, the inside of intersection P may be set as the emergency travelable area R12 in cases where the signal is amber or when the subject vehicle V is traveling a dilemma zone of the intersection P.

Accordingly, based on the attributes of the surrounding areas, the attribute identification unit 14 adds no-stop areas, stop-allowed areas, and no-entry areas and the like to the area types in the travel area information. The attribute identification unit 14 outputs the updated travel area information to the autonomous travel determination unit 15.

The autonomous travel determination unit 15 retrieves the travel area information from the attribute identification unit 14, determines an area, from the surrounding area, that is autonomously travelable for the subject vehicle V (referred to as autonomous travelable areas) based on this information, and includes the information about the autonomous travelable area in the travel area information and outputs to the route creation unit 16. Specifically, the autonomous travel determination unit 15 determines the regular travelable area R11, the emergency travelable area R12, the surrounding travelable area RIX, and predicted travelable area RIP as the autonomous travelable areas, determines the non-travel area R2 and the predicted non-travel area R2P as autonomous non-travel areas, and determines the no-stop area R3 as an area of the autonomous travelable area where the subject vehicle V is not allowed to a stop.

The route creation unit 16 retrieves the travel area information from the autonomous travel determination unit 15, and creates the travel route for the subject vehicle V within the autonomous travelable area based on the travel area information. The travel route for the subject vehicle V, created by the route creation unit 16, is output to the vehicle control ECU 24 via the external interface 20.

The reception unit 17 is connected to the vehicle sensor 21, the surrounding monitoring sensors 22, the communication unit 23, and the vehicle control ECU 24 via the external interface 20. The reception unit 17 receives vehicle information of the subject vehicle V from the vehicle sensor 21, receives surrounding monitoring sensor information from the surrounding monitoring sensor 22, and receives vehicle information of the surrounding vehicles from the communication unit 23. Also, the reception unit 17 is connected to the storage device 30 and retrieves the map information 31 from the storage device 30.

The position estimation unit 19 retrieves the map information and the position information contained in the vehicle information of the subject vehicle V from the reception unit 17 and collates both types of information to determine the position of the subject vehicle V.

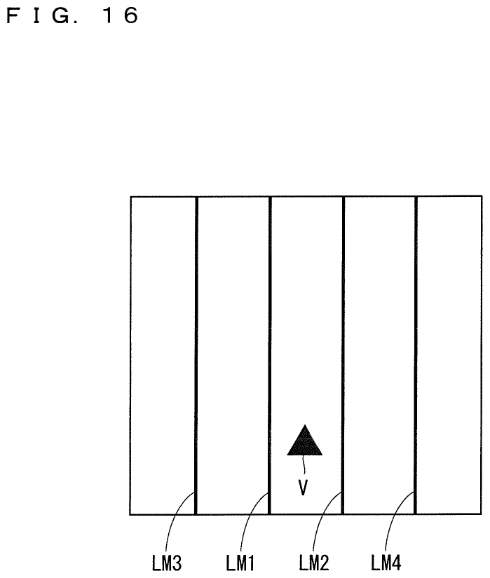

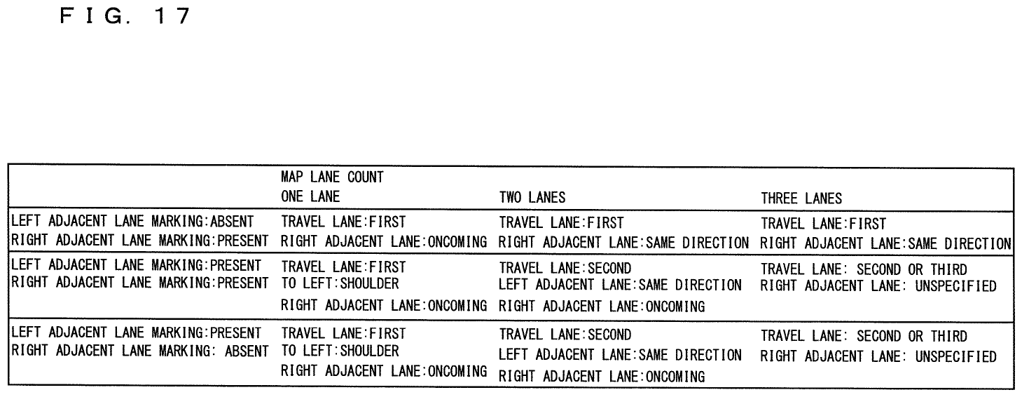

The lane estimation unit 18 retrieves the map information, the lane marking information, and the position information of the subject vehicle V from the position estimation unit 19 and estimates the travel lane of the subject vehicle V based on these types of information. FIG. 16 illustrates the relationship between the position of the subject vehicle V and the lane markings. The lane marking on the left side, which serves as the left boundary line of the travel lane of the subject vehicle V, is referred to as the left lane marking LM1, whereas the lane marking on the right side, which serves as the right boundary line of the travel lane, is referred to as the right lane marking LM2. Also, the lane marking that is one lane marking to the left of the left lane marking LM1 is referred to as the left adjacent lane marking LM3 and the lane marking that is one lane marking to the right of the right lane marking LM2 is referred to as the right adjacent lane marking LM4. FIG. 17 illustrates an example of estimating the travel lane of the subject vehicle V based on the presence or absence of the left adjacent lane marking LM3 and the right adjacent lane marking LM4, as well as map information.

In a case of the left adjacent lane marking LM3 being absent and the right adjacent lane marking LM4 being present, the travel lane is estimated as follows, depending on the number of lanes in the map information (referred to as “map lane count” hereinafter). When the map lane count is one, the travel lane is estimated to be the first lane, and the lane immediately to the right of the travel lane (referred to as the “right adjacent lane”) is estimated to be an oncoming lane. When the map lane count is two or three, the travel lane is estimated to be the first lane, and the right adjacent lane is estimated to be a lane in the same direction.

In a case of the left adjacent lane marking LM3 and the right adjacent lane marking LM4 being both present, or a case of the left adjacent lane marking LM3 being present and the right adjacent lane marking LM4 being absent, the travel lane is estimated as follows, depending on the map lane count. When the map lane count is one, the travel lane is estimated to be the first lane, the right adjacent lane is estimated to be an oncoming lane, and a wide shoulder is to be estimated to be present to the left of the travel lane. When the map lane count is two, the travel lane is estimated to be the second lane, the lane immediately to the left of the travel lane (referred to as the “left adjacent lane”) is estimated to be a lane in the same direction, and the right adjacent lane is estimated to be an oncoming lane. When the map lane count is three, the travel lane is estimated to be either the second or third lane, and whether the right adjacent lane is in the same or the oncoming direction is unspecified.

### <A-2. Operation>

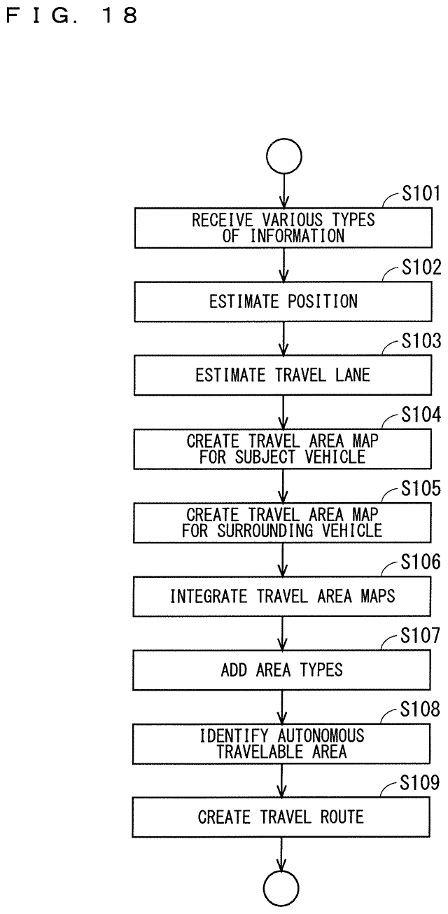

FIG. 18 is a flowchart illustrating the overall operation of the travel area determination device 101. The following is a description of the overall operation of the travel area determination device 101, following FIG. 18.

First, the reception unit 17 receives various types of information (Step S101). Specifically, the reception unit 17 retrieves the vehicle information of the subject vehicle V from the vehicle sensor 21, the free space information, the lane marking information, and the obstacle information from the surrounding monitoring sensor 22, the vehicle information of surrounding vehicles from the communication unit 23, and the medium-definition map information 32 from the storage device 30.

Afterward, the position estimation unit 19 retrieves the vehicle information of the subject vehicle V and the medium-definition map information 32 from the reception unit 17, and based on these, estimates the position of the subject vehicle V (Step S102).

Next, the lane estimation unit 18 retrieves the position information of the subject vehicle V from the position estimation unit 19, the medium-definition map information 32 and the lane marking information from the reception unit 17, and based on these, estimates the travel lane of the subject vehicle V (Step S103).

Afterwards, the travel area creation unit 11 retrieves the position information and the travel lane information of the subject vehicle V from the lane estimation unit 18, and retrieves the free space information, the lane marking information, and the obstacle information from the reception unit 17. Then, based on these types of information, the travel area creation unit 11 determines an area type of a surrounding area and creates a travel area map, which represents the travel area information for the subject vehicle V (Step S104). Further, the travel area creation unit 11 sets the processing priority based on the area type of the previously determined surrounding areas and changes the processing order or frequency accordingly.

Next, the travel area processing unit 12 retrieves the surrounding vehicle information from the reception unit 17 and creates a travel area map, which represents the travel area information of the surrounding vehicles, using the free space information, the lane marking information, and the obstacle information contained in the surrounding vehicle information (Step S105).

Afterward, the integration unit 13 integrates the travel area map for the subject vehicle V and the travel area map for the surrounding vehicles (Step S106).

Next, the attribute identification unit 14 adds the area types such as the stop-allowed areas and the no-stop areas to the integrated travel area map integrated in Step S106 (Step S107).

Afterward, the autonomous travel determination unit 15 identifies areas in the travel area map that are autonomously travelable (Step S108).

Next, the route creation unit 16 creates a route for traveling in the area that are autonomously travelable and transmits it to the vehicle control ECU 24 via the external interface 20 (Step S109).

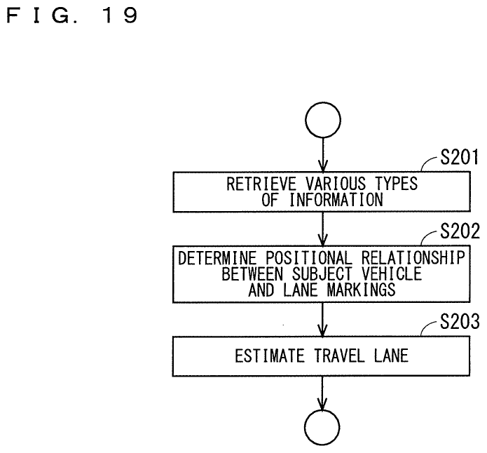

FIG. 19 is a flowchart illustrating the operation of the lane estimation unit 18. In the following, the operation of the lane estimation unit 18 is described following FIG. 19.

First, the lane estimation unit 18 retrieves the position information of the subject vehicle V from the position estimation unit 19 and retrieves the lane marking information and map information from the reception unit 17 (Step S201).

Next, the lane estimation unit 18 determines the positional relationship between the subject vehicle V and the lane markings based on the lane marking information (Step S202).

Afterward, based on the determination result from Step S202 and the map lane count, the lane estimation unit 18 estimates the travel lane of the subject vehicle V (Step S203).

Note that the position information retrieved by the lane estimation unit 18 in Step S201 is measured by the vehicle sensor 21. If the accuracy of this position information is high, the lane estimation unit 18 may estimate the travel lane based on the position information and map information without using the lane marking information.

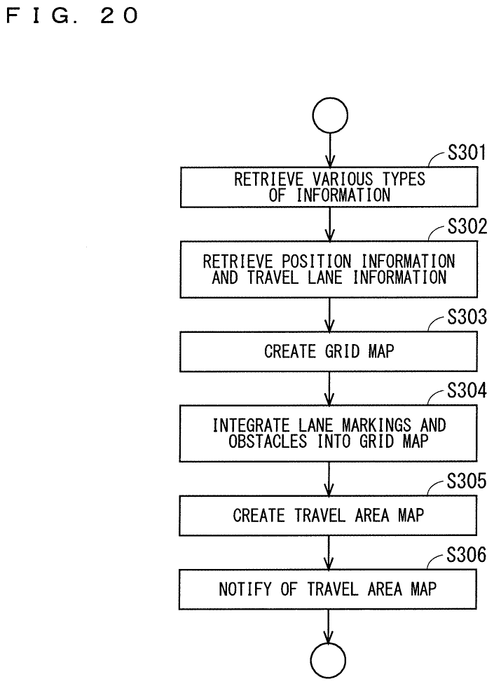

FIG. 20 is a flowchart illustrating the operation of the travel area creation unit 11. In the following, the operation of the travel area creation unit 11 is described following FIG. 20.

First, the travel area creation unit 11 retrieves the free space information, the lane marking information, the obstacle information, and the map information from the reception unit 17 (Step S301).

Next, the travel area creation unit 11 retrieves the position information and the travel lane information of the subject vehicle V from the lane estimation unit 18 (Step S302).

Afterward, the travel area creation unit 11 creates a grid map from the boundary points of the free space information (Step S303).

Next, the travel area creation unit 11 integrates the lane markings and obstacles into the grid map (Step S304).

Afterward, the travel area creation unit 11 determines the area types of the surrounding areas on the grid map based on the lane markings and the free space, and creates the travel area map (Step S305).

Next, the travel area creation unit 11 notifies the integration unit 13 of the travel area map (Step S306).

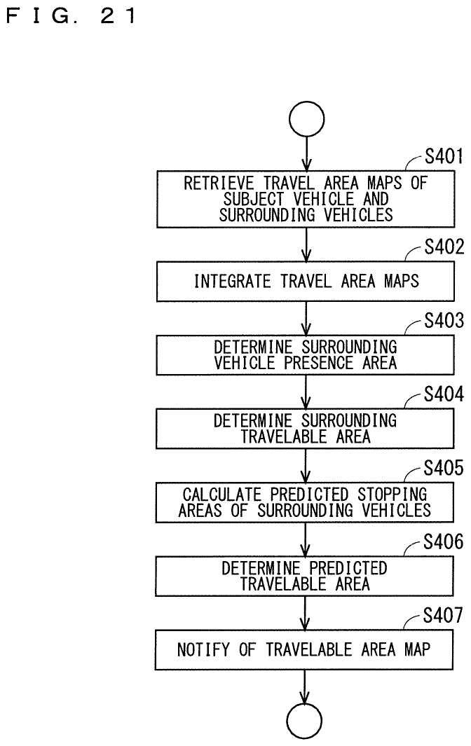

FIG. 21 is a flowchart illustrating the operation of the integration unit 13. In the following, the operation of the integration unit 13 is described following FIG. 21.

First, the integration unit 13 retrieves the travel area map for the subject vehicle V from the travel area creation unit 11, and the travel area map for the surrounding vehicles from the travel area processing unit 12 (Step S401).

Next, the integration unit 13 integrates the travel area map for the subject vehicle V with the travel area map for the surrounding vehicles (Step S402).

Afterward, the integration unit 13 determines a surrounding vehicle presence area considering the dimensions such as the length and width of the surrounding vehicles (Step S403).

Next, the integration unit 13 determines the travelable areas and the presence areas of the surrounding vehicles as the surrounding travelable area (Step S404).

Afterward, the integration unit 13 calculates the predicted stopping positions of the surrounding vehicles (Step S405).

Next, the integration unit 13 determines an area from the current position of surrounding vehicles to the predicted stopping position as the predicted travelable area (Step S406).

Afterward, the integration unit 13 outputs the integrated travelable area map to the attribute identification unit 14 (Step S407).

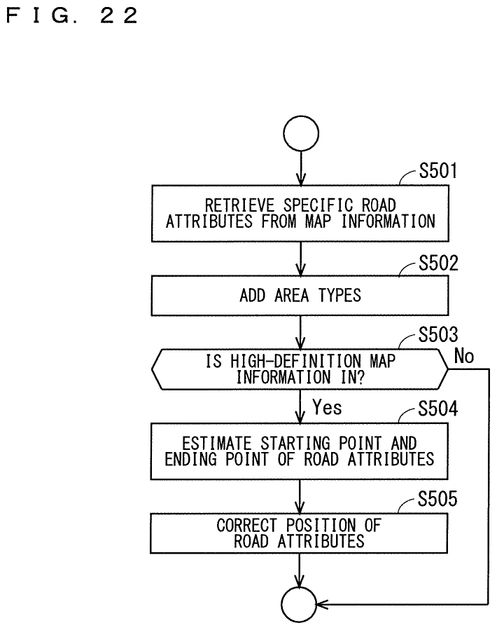

FIG. 22 is a flowchart illustrating the operation of the attribute identification unit 14. In the following, the operation of the attribute identification unit 14 is described following FIG. 22.

First, the attribute identification unit 14 retrieves the travelable area map from the integration unit 13 and the map information from the reception unit 17, respectively. Then, the attribute identification unit 14 retrieves the positions of specific road attributes such as intersections, level crossings, tunnels, or crosswalks from the map information (Step S501).

Next, the attribute identification unit 14 adds the area types such as no-stop areas to the travel area map based on the road attributes retrieved in Step S501 (Step S502).

Afterwards, the attribute identification unit 14 determines whether high-definition map information 33 is stored in the storage device 30 (Step S503). When the high-definition map information 33 is stored in Step S503, the attribute identification unit 14 terminates the process.

When the high-definition map information 33 is not stored in Step S503, the attribute identification unit 14 estimates the starting point and the ending point of the road attributes retrieved in Step S501 based on the shape of the travelable area (Step S504).

After Step S504, the attribute identification unit 14 corrects the position of road attributes in the travelable area map based on the estimation results from Step S504 (Step S505).

### <A-3. Effect>

The travel area determination device 101 includes the travel area creation unit 11 that determines the area type of the surrounding area of the subject vehicle V based on the measurement information from the surrounding monitoring sensor 22 installed in the subject vehicle V and creates travel area information for the subject vehicle V including the information about the area type, the integration unit 13 that integrates the surrounding travel area information including the information about the area type of the surrounding area of the surrounding vehicles, which is determined based on the measurement result of the surrounding monitoring sensor installed in the surrounding vehicles which are vehicles present around the subject vehicle V and the travel area information, and the autonomous travel determination unit 15 that determines the autonomous travelable area that is autonomously travelable for the subject vehicle, based on the integrated travel area information. The travel area creation unit 11 determines the free space FS being an area between the subject vehicle V and an obstacle as the travelable area R1 where the subject vehicle V is travelable based on the position of the obstacle existing around the subject vehicle V measured by the surrounding monitoring sensor 22 installed in the subject vehicle V. The integration unit 13 determines the travelable area where the surrounding vehicles are travelable, which is determined based on the measurement result of the surrounding monitoring sensor installed in the surrounding vehicles, as the surrounding travelable area RIX where the subject vehicle V is travelable, and integrate this and the travel area information. The autonomous travel determination unit 15 determines the travelable area R1 and the surrounding travelable area RIX of the subject vehicle as the autonomous travelable areas. A travel route the subject vehicle V autonomously travels is created in the autonomous travelable area. Therefore, the travel area determination device 101 can determine the travelable area of the subject vehicle V even in the presence of obstacles in the vicinity. Also, the travel area determination device 101 can determine the travelable area of the area where the subject vehicle V cannot detect by utilizing the surrounding travel area information detected by the surrounding vehicles.

A travel area determination method of Embodiment 1 includes determining the area type of the surrounding area of the subject vehicle V based on the measurement information from the surrounding monitoring sensor 22 installed in the subject vehicle V, creating travel area information including the information about the area type, integrating the surrounding travel area information including the information about the area type of the surrounding area of the surrounding vehicles, which is determined based on the measurement result of the surrounding monitoring sensor installed in the surrounding vehicles which are vehicles present around the subject vehicle V and the travel area information, determining the autonomous travelable area, where the subject vehicle is autonomously travelable, based on the integrated travel area information, determining the free space FS being an area between the subject vehicle V and an obstacle as the travelable area R1 where the subject vehicle V is travelable based on the position of the obstacle existing around the subject vehicle V measured by the surrounding monitoring sensor 22 installed in the subject vehicle V, determining the travelable area where the surrounding vehicles are travelable, which is determined based on the measurement result of the surrounding monitoring sensor installed in the surrounding vehicles, as the surrounding travelable area RIX where the subject vehicle V is travelable, and integrating this and the travel area information, determining the travelable area R1 and the surrounding travelable area RIX of the subject vehicle as the autonomous travelable areas, and creating a travel route the subject vehicle V autonomously travels in the autonomous travelable area. Therefore, the travel area determination device of Embodiment 1, the determination of the travelable area of the subject vehicle V is ensured even in the presence of obstacles in the vicinity. Also, the travel area determination device of Embodiment 1, the determination of the travelable area of the area where the subject vehicle cannot detect is ensured by utilizing the surrounding travel area information detected by the surrounding vehicles.

The Embodiments can be combined, appropriately modified or omitted. The foregoing description is in all aspects illustrative and not restrictive. It is therefore understood that numerous modification examples can be devised.

### EXPLANATION OF REFERENCE SIGNS

11 travel area creation unit, 12 travel area processing unit, 13 integration unit, 14 attribute identification unit, 15 autonomous travel determination unit, 16 route creation unit, 17 reception unit, 18 lane estimation unit, 19 position estimation unit, external interface, 1 vehicle sensor, 22 surrounding monitoring sensor, 23 communication unit, 24 vehicle control ECU, 30 storage device, 31 map information, 32 medium-definition map information, 33 high-definition map information, 34 shoulder, 50 processor, 101 travel area determination device, BP boundary point, FS free space, LM lane marking, R surrounding area, R1 travelable area, R11 regular travelable area, R12 emergency travelable area, R1A travelable area, R1B travelable area, RIP predicted travelable area, R1X surrounding travelable area, R2 non-travel area, R2P predicted non-travel area, R3 no-stop area, R4 stop-allowed area, R5 no-entry area, V subject vehicle.

1. A travel area determination device comprising:
a processor to execute a program; and
a memory to store the program which, when executed by the processor, performs processes of, determining an area type of a surrounding area of a subject mobile object based on measurement information from a surrounding monitoring sensor installed in the subject mobile object and creating travel area information including information about the area type;
integrating surrounding travel area information including the information about the area type of a surrounding area of a surrounding mobile object, which is determined based on a measurement result of the surrounding monitoring sensor installed in the surrounding mobile object which is a mobile object present around the subject mobile object and the travel area information;
determining an autonomous travelable area, where the subject mobile object is autonomously travelable, based on the integrated travel area information, wherein;
determining a free space being an area between the subject mobile object and an obstacle as a travelable area where the subject mobile object is travelable based on a position of the obstacle existing around the subject mobile object measured by the surrounding monitoring sensor installed in the subject mobile object;
determining a travelable area where the surrounding mobile object is travelable, which is determined based on the measurement result of the surrounding monitoring sensor installed in the surrounding mobile object, as a surrounding travelable area where the subject mobile object is travelable, and
integrating the travelable area and the travel area information;
determining the travelable area and the surrounding travelable area of the subject mobile object as the autonomous travelable areas; and
a travel route the subject mobile object autonomously travels being created in the autonomous travelable area.

2. The travel area determination device according to claim 1, further comprising
creating the travel route the subject mobile object autonomously travels in the autonomous travelable area.

3. The travel area determination device according to claim 2, wherein
the travelable area includes a regular travelable area and an emergency travelable area having a lower priority for traveling of the subject mobile object compared to that of the regular travelable area,
based on travel lane information of the subject mobile object, a travel lane and a same-direction lane of the subject mobile object within the free space are determined as the regular travelable area, and an oncoming lane of the subject mobile object and a shoulder within the free space are determined as the emergency travelable area, and
the travel route in the emergency travelable area is created when the travel route is unable to be created in the regular travelable area.

4. The travel area determination device according to claim 3, wherein
a travel lane of the subject mobile object is estimated based on information on a lane marking measured by the surrounding monitoring sensor installed in the subject mobile object and information of lane count included in map information.

5. The travel area determination device according to claim 4, wherein
a shape of the lane marking measured by the surrounding monitoring sensor installed in the subject mobile object is corrected based on curvature information of a road included in the map information and the travel lane of the subject mobile object is estimated based on a shape of the corrected lane marking.

6. The travel area determination device according to claim 1, wherein
a predicted stopping position being a position at which the surrounding mobile object is to stop after initiation of emergency braking from a current moment is calculated, and an area, from a current position of the surrounding mobile object traveling ahead of the subject mobile object in a same direction to the predicted stopping position, is determined as a predicted travelable area where the subject mobile object is travelable, and
the predicted travelable area is determined as the autonomous travelable area.

7. The travel area determination device according to claim 6, wherein
an area other than the free space is determined as a non-travel area where the subject mobile object is unable to travel,
an area, from a current position of the surrounding mobile object traveling ahead of the subject mobile object in an oncoming direction to the predicted stopping position is determined as a predicted non-travel area where the subject mobile object is unable to travel, and
the non-travel area and the predicted non-travel area of the subject mobile object are not determined as the autonomous travelable areas.

8. The travel area determination device according to claim 1, further comprising
an area of specific road attribute including at least any of an intersection, a level crossing, a tunnel, and a crosswalk is determined as a no-stop area where the subject mobile object prohibited from stopping, and is included a determination result in the travel area information, wherein
when autonomously traveling according to the travel route, the subject mobile object does not stop in the no-stop area.

9. The travel area determination device according to claim 8, comprising
determining the position of the area of the specific road attribute using map information and correcting the determined position of the area of the specific road attribute based on information on the free space measured by the surrounding monitoring sensor installed in the subject mobile object.

10. The travel area determination device according to claim 1, wherein
the travel area determination device comprises a cloud server.

11. A travel area determination method comprising:
determining an area type of a surrounding area of a subject mobile object based on measurement information from a surrounding monitoring sensor installed in the subject mobile object and creating travel area information including information about the area type;
integrating surrounding travel area information including the information about the area type of a surrounding area of a surrounding mobile object, which is determined based on a measurement result of the surrounding monitoring sensor installed in the surrounding mobile object which is a mobile object present around the subject mobile object and the travel area information;
determining an autonomous travelable area, where the subject mobile object is autonomously travelable, based on the integrated travel area information;
determining a free space being an area between the subject mobile object and an obstacle as a travelable area where the subject mobile object is travelable based on a position of the obstacle existing around the subject mobile object measured by the surrounding monitoring sensor installed in the subject mobile object;
determining a travelable area where the surrounding mobile object is travelable, which is determined based on the measurement result of the surrounding monitoring sensor installed in the surrounding mobile object, as a surrounding travelable area where the subject mobile object is travelable, and integrating the travelable area and the travel area information;
determining the travelable area and the surrounding travelable area of the subject mobile object as the autonomous travelable areas; and
a travel route the subject mobile object autonomously travels being created in the autonomous travelable area.
